(19) United States
(12) Patent Application Publication
(10) Pub. No.: US 2024/0349946 A1
(43) Pub. Date: Oct. 24, 2024

(54) HINGED STRUCTURE OF VEGETABLE CUTTER

(71) Applicant: SHUANGMA PLASTIC MANUFACTURING INC., Taizhou (CN)

(72) Inventor: Cuihong CHEN, Taizhou (CN)

(21) Appl. No.: 18/357,071

(22) Filed: Jul. 21, 2023

Related U.S. Application Data
(63) Continuation of application No. PCT/CN2023/097713, filed on Jun. 1, 2023.

(30) Foreign Application Priority Data
Apr. 23, 2023 (CN) 202320958263.8

(51) Int. Cl. A47J 43/07; B26D 1/03

(52) U.S. Cl. CPC A47J 43/07; B26D 1/03

(57) ABSTRACT

A hinged structure of a vegetable cutter comprises a vegetable cutter body and a vegetable cutting pressing plate; the vegetable cutter body is provided with a vegetable cutting knife frame, the vegetable cutting pressing plate is provided with a material pressing plate, and the material pressing plate is capable of pressing a material on the vegetable cutting knife frame. The hinged structure of the vegetable cutter is characterized in that: a detachably connected hinged portion is arranged between the vegetable cutter body and the vegetable cutting pressing plate, the hinged portion comprises a hinged shaft and a limiting device for limiting the hinged shaft, and rotary connection between the vegetable cutter body and the vegetable cutting pressing plate is realized through the hinged shaft and the limiting device, so that a structure is simple, and a user disassembles and assembles the vegetable cutting pressing plate conveniently.

### CROSS-REFERENCE TO RELATED APPLICATIONS

This application is a continuation of International Patent Application No. PCT/CN2023/097713 with a filing date of Jun. 1, 2023, designating the United States, now pending, and further claims priority to Chinese Patent Application No. 202320958263. 8 with a filing date of Apr. 23, 2023. The content of the aforementioned applications, including any intervening amendments thereto, are incorporated herein by reference.

### TECHNICAL FIELD

The application relates to the technical field of kitchen supplies, and particularly to a hinged structure of a vegetable cutter.

### BACKGROUND OF THE PRESENT INVENTION

Vegetable cutter is a common food processing device, and generally comprises a base and a pressing cover, wherein the base is provided with a cutter head, and the pressing cover is provided with a pressing block matched with the cutter head. When in use, food is placed on the cutter head, and then the food is pressed by the pressing cover, so that a blade on the cutter head may cut the food into pieces. In order to facilitate the disassembly of the base and the pressing cover, a telescopic rotating shaft is generally used, and the rotating shaft is pressed inwardly to retract when the base and the pressing cover need to be disassembled, so that the base is separated from the pressing cover. Most of existing telescopic rotating shafts are supported by a spring, thus being inconvenient to use.

Chinese patent with the publication number CN218428477U discloses a vegetable cutter, which comprises a base and a pressing cover, wherein the pressing cover is detachably hinged on the base through a telescopic rotating shaft, the base is provided with a cutter head, a bottom portion of the pressing cover is provided with a pressing block matched with the cutter head, the rotating shaft comprises a first rotating shaft and a second rotating shaft which are distributed left and right, the first rotating shaft and the second rotating shaft are respectively provided with a first rack and a second rack which are oppositely distributed, a driving gear is arranged between the first rack and the second rack, two sides of the driving gear are respectively meshed with the first rack and the second rack, and when the driving gear rotates in different directions, the rotating shaft is driven to extend and retract respectively. The vegetable cutter provided by the application improves the rotating shaft structure, so as to be assembled and disassembled more conveniently.

The above technical solution has the following defects: the whole structure is still complicated by extending and retracting the rotating shaft, which is inconvenient for users in a disassembly process.

### SUMMARY OF PRESENT INVENTION

Aiming at the defects in the prior art, the application is intended to provide a hinged structure of a vegetable cutter, which has the advantages of a simple structure and convenience for a user to disassemble and assemble a vegetable cutting pressing plate.

The above technical purpose of the application is achieved by the following technical solution: a hinged structure of a vegetable cutter comprises a vegetable cutter body and a vegetable cutting pressing plate; the vegetable cutter body is provided with a vegetable cutting knife frame, the vegetable cutting pressing plate is provided with a material pressing plate, and the material pressing plate is capable of pressing a material on the vegetable cutting knife frame, wherein a detachably connected hinged portion is arranged between the vegetable cutter body and the vegetable cutting pressing plate, and the hinged portion comprises a hinged shaft and a limiting device for limiting the hinged shaft.

Further, the limiting device comprises a first clamping strip and a first clamping groove arranged in the vegetable cutter body, one end of the first clamping strip is hinged with one end of the hinged shaft, the other end of the first clamping strip is provided with a first hook, and the first hook is capable of being clamped with the first clamping groove.

Further, the limiting device comprises a first clamping strip and a first clamping groove arranged in the vegetable cutter body, one end of the first clamping strip is hinged with one end of the hinged shaft, the other end of the first clamping strip is provided with a first hook, and the first hook is capable of being clamped with the first clamping groove.

Further, a hole wall of the first mounting hole or the second mounting hole is provided with a third mounting hole, the limiting device comprises a groove arranged on the hinged shaft and a clamping block movably arranged in the third mounting hole, and the clamping block is capable of being pressed into the groove.

Further, one end of the third mounting hole far away from the hinged shaft is detachably provided a plug.

Further, a spring is arranged between the plug and the clamping block.

Further, the hinged shaft is hollow, and two ends of the hinged shaft are respectively provided with a block.

Further, the limiting device comprises a second clamping strip and a second clamping groove arranged at one end of the hinged shaft, one end of the second clamping strip is hinged with the vegetable cutter body, the other end of the second clamping strip is provided with a second hook, and the second hook is capable of being clamped with the second clamping groove.

Further, a vegetable cutter further comprises a storage barrel, wherein the storage barrel is located at a lower end of the vegetable cutter body and detachably connected with the vegetable cutter body.

Further, a bottom portion of the storage barrel is provided with a plurality of anti-skid protrusions.

To sum up, compared with the prior art, the application has the beneficial effects that:

the rotary connection between the vegetable cutter body and the vegetable cutting pressing plate is realized through the hinged shaft and the limiting device, so that a structure is simple, and a user disassembles and assembles the vegetable cutting pressing plate conveniently.

### DESCRIPTION OF THE DRAWINGS

FIG. 1 is a schematic structural diagram of Embodiment 1;

FIG. 2 is an exploded view of a part of Embodiment 1;

FIG. 3 is a schematic structural diagram of a vegetable cutter body in Embodiment 2; and

FIG. 4 is a schematic structural diagram of a part of a limiting device in Embodiment 2.

Reference numerals: 1 refers to vegetable cutter body; 2 refers to vegetable cutting pressing plate; 3 refers to vegetable cutting knife frame; 4 refers to material pressing plate; 5 refers to hinged portion; 6 refers to hinged shaft; 7 refers to limiting device; 8 refers to first mounting hole; 9 refers to second mounting hole; 10 refers to first clamping strip; 11 refers to first clamping groove; 12 refers to first hook; 13 refers to storage barrel; 14 refers to anti-skid protrusion; 15 refers to third mounting hole; 16 refers to groove; 17 refers to clamping block; 18 refers to plug; 19 refers to spring; and 20 refers to block.

### DETAILED DESCRIPTION OF PREFERRED EMBODIMENTS

The application is further described in detail hereinafter with reference to the drawings.

### Embodiment 1

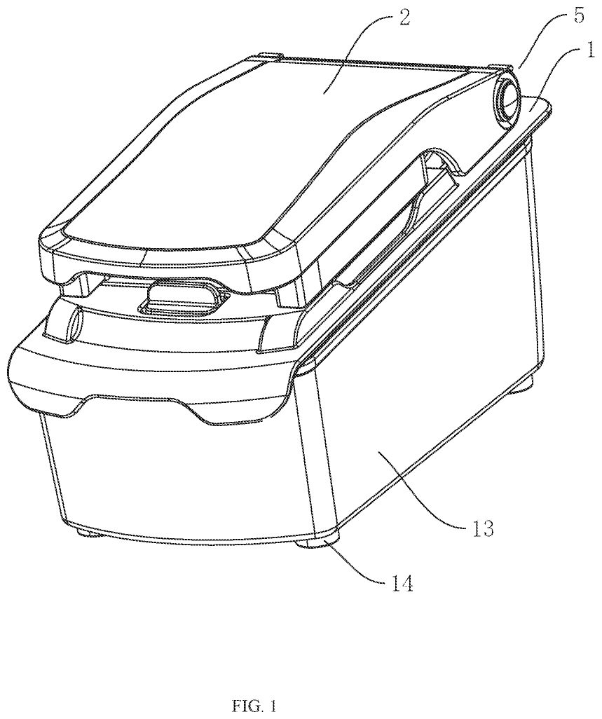

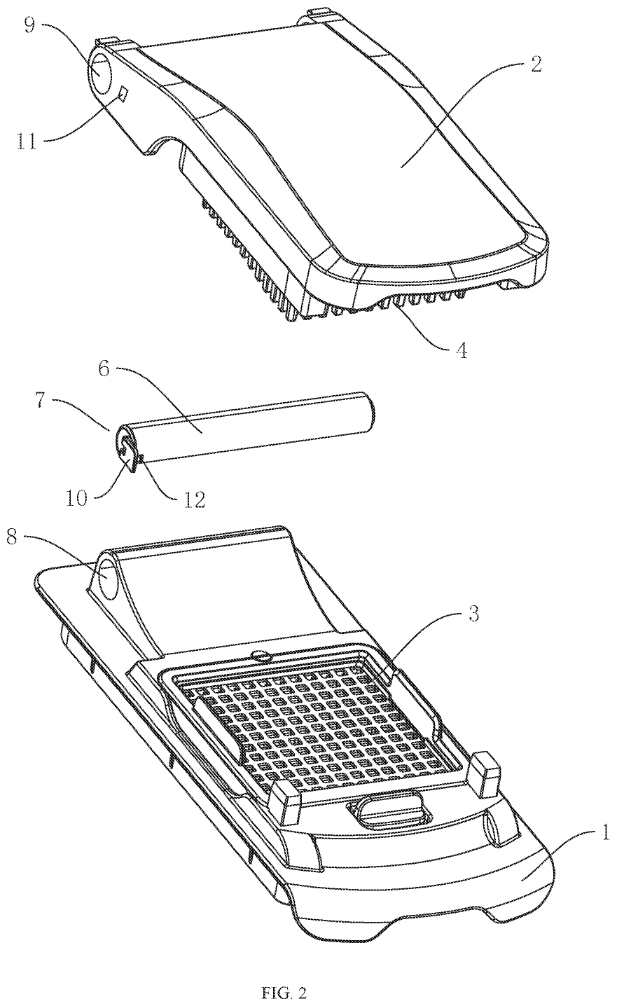

A hinged structure of a vegetable cutter, as shown in FIG. 1 to FIG. 2, comprises a vegetable cutter body 1 and a vegetable cutting pressing plate 2. The vegetable cutter body 1 is provided with a vegetable cutting knife frame 3, the vegetable cutting pressing plate 2 is provided with a material pressing plate 4, and the material pressing plate 4 is capable of pressing a material on the vegetable cutting knife frame 3.

A detachably connected hinged portion 5 is arranged between the vegetable cutter body 1 and the vegetable cutting pressing plate 2, and the hinged portion 5 comprises a hinged shaft 6 and a limiting device 7 for limiting the hinged shaft 6. For a position of the hinged shaft 6, the vegetable cutter body 1 is provided with a first mounting hole 8, the vegetable cutting pressing plate 2 is provided with a second mounting hole 9, the hinged shaft 6 is mounted in the first mounting hole 8 and the second mounting hole 9, and relative rotation of the vegetable cutting pressing plate 2 is realized through the hinged shaft 6.

The limiting device 7 is used to limit an axial direction of the hinged shaft 6 to prevent the hinged shaft 6 from falling off when a user turns over the vegetable cutting pressing plate 2. Specifically, the limiting device 7 comprises a first clamping strip 10 and a first clamping groove 11 arranged in the vegetable cutter body 1, one end of the first clamping strip 10 is hinged with one end of the hinged shaft 6, the other end of the first clamping strip 10 is provided with a first hook 12, and the first hook 12 is capable of being clamped with the first clamping groove 11, so that the hinged shaft 6 cannot be easily separated from the first mounting hole 8 and the second mounting hole 9 through cooperation of the first clamping groove 11 and the first hook 12. Moreover, when the vegetable cutter pressing plate is disassembled and assembled, the hook only needs to be pulled out by a hand, and then the hinged shaft 6 is drawn out, so as to separate the vegetable cutter body 1 from the vegetable cutter pressing plate 2.

A vegetable cutter comprises the hinged structure of the vegetable cutter above, and further comprises a storage barrel 13. The storage barrel 13 is located at a lower end of the vegetable cutter body 1 and detachably connected with the vegetable cutter body 1, which specifically refers to press connection or buckle connection, and a bottom portion of the storage barrel 13 is provided with a plurality of anti-skid protrusions 14.

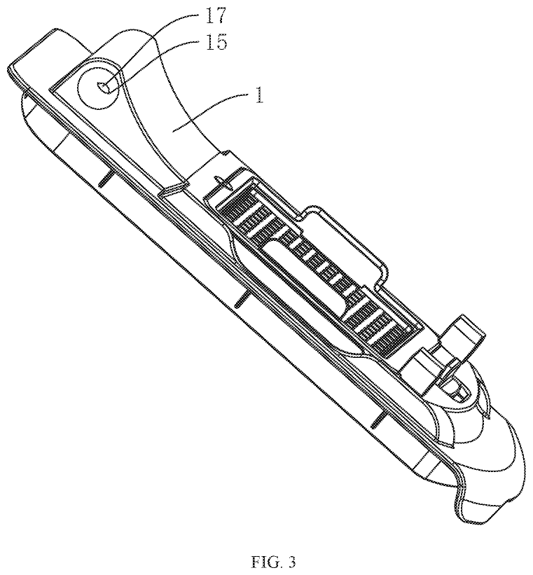

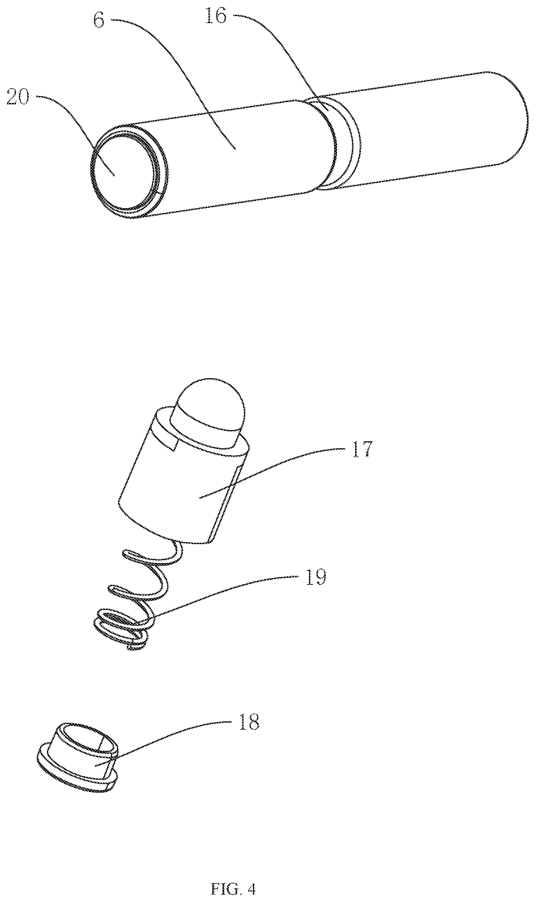

Embodiment 2: as shown in FIG. 3 to FIG. 4, Embodiment 2 is different from Embodiment 1 in that: a hole wall of the first mounting hole 8 or the second mounting hole 9 is provided with a third mounting hole 15, and the limiting device 7 comprises a groove 16 arranged on the hinged shaft 6 and a clamping block 17 movably arranged in the third mounting hole 15. One end of the third mounting hole 15 far away from the hinged shaft 6 is detachably provided a plug 18. A spring 19 is arranged between the plug 18 and the clamping block 17. Under an action of the spring 19, the clamping block 17 is capable of being pressed into the groove 16, and when the clamping block 17 is pressed into the groove 16, the hinged shaft 6 cannot be easily removed, thus limiting the hinged shaft 6. When the vegetable cutter pressing plate is disassembled, only by applying a pressure to any end of the hinged shaft 6, the clamping block 17 may be pressed to retract under the pressure, and the hinged shaft 6 is removed in an opposite direction of the applied end. The hinged shaft 6 is hollow, and two ends of the hinged shaft 6 are respectively provided with a block 20.

Embodiment 3: Embodiment 3 is different from Embodiment 1 in that: the limiting device 7 comprises a second clamping strip and a second clamping groove arranged at one end of the hinged shaft 6, one end of the second clamping strip is hinged with the vegetable cutter body 1, the other end of the second clamping strip is provided with a second hook, and the second hook is capable of being clamped with the second clamping groove.

Embodiment 4: Embodiment 4 is different from Embodiment 2 in that: the third mounting hole 15 is arranged in a side wall of the hinged shaft 6, the spring 19 and the clamping block 17 are movably arranged in the third mounting hole 15, and the groove 16 is arranged in the hole wall of the first mounting hole 8 or the second mounting hole 9.

The above are only exemplary embodiments of the application, and not used to limit the scope of protection of the application, and the scope of protection of the application is determined by the appended claims.

We claim:

1. A hinged structure of a vegetable cutter, comprising a vegetable cutter body (1) and a vegetable cutting pressing plate (2); the vegetable cutter body (1) being provided with a vegetable cutting knife frame (3), the vegetable cutting pressing plate (2) being provided with a material pressing plate (4), and the material pressing plate (4) being capable of pressing a material on the vegetable cutting knife frame (3), wherein a detachably connected hinged portion (5) is arranged between the vegetable cutter body (1) and the vegetable cutting pressing plate (2), and the hinged portion (5) comprises a hinged shaft (6) and a limiting device (7) for limiting the hinged shaft (6).

2. The hinged structure of the vegetable cutter according to claim 1, wherein the vegetable cutter body (1) is provided with a first mounting hole (8), the vegetable cutting pressing plate (2) is provided with a second mounting hole (9), and the hinged shaft (6) is mounted in the first mounting hole (8) and the second mounting hole (9).

3. The hinged structure of the vegetable cutter according to claim 2, wherein the limiting device (7) comprises a first clamping strip (10) and a first clamping groove (11) arranged in the vegetable cutter body (1), one end of the first clamping strip (10) is hinged with one end of the hinged shaft (6), the other end of the first clamping strip (10) is provided with a first hook (12), and the first hook (12) is capable of being clamped with the first clamping groove (11).

4. The hinged structure of the vegetable cutter according to claim 2, wherein a hole wall of the first mounting hole (8) or the second mounting hole (9) is provided with a third mounting hole (15), the limiting device (7) comprises a groove (16) arranged on the hinged shaft (6) and a clamping block (17) movably arranged in the third mounting hole (15), and the clamping block (17) is capable of being pressed into the groove (16).

5. The hinged structure of the vegetable cutter according to claim 4, wherein one end of the third mounting hole (15) far away from the hinged shaft (6) is detachably provided a plug (18).

6. The hinged structure of the vegetable cutter according to claim 5, wherein a spring (19) is arranged between the plug (18) and the clamping block (17).

7. The hinged structure of the vegetable cutter according to claim 6, wherein the hinged shaft (6) is hollow, and two ends of the hinged shaft (6) are respectively provided with a block (20).

8. The hinged structure of the vegetable cutter according to claim 2, wherein the limiting device (7) comprises a second clamping strip and a second clamping groove arranged at one end of the hinged shaft (6), one end of the second clamping strip is hinged with the vegetable cutter body (1), the other end of the second clamping strip is provided with a second hook, and the second hook is capable of being clamped with the second clamping groove.

9. A vegetable cutter, comprising the hinged structure of the vegetable cutter according to claim 1, and further comprising a storage barrel (13), wherein the storage barrel (13) is located at a lower end of the vegetable cutter body (1) and detachably connected with the vegetable cutter body (1).

10. The vegetable cutter according to claim 9, wherein a bottom portion of the storage barrel (13) is provided with a plurality of anti-skid protrusions (14).
